(19) United States
(12) Patent Application Publication
(10) Pub. No.: US 2026/0012215 A1
(43) Pub. Date: Jan. 8, 2026

(54) PASSIVE INTERMODULATION INTERFERENCE OPTIMIZED ANTENNA CONFIGURATION

(71) Applicant: Quintel Cayman Limited, Grand Cayman (KY)

(72) Inventors: Peter Chun Teck Song, San Jose, CA (US); David Edwin Barker, Stockport (GB)

(21) Appl. No.: 19/260,430

(22) Filed: Jul. 4, 2025

Related U.S. Application Data
(60) Provisional application No. 63/668,155, filed on Jul. 5, 2024.

(51) Int. Cl. H04B 1/12; H01Q 1/24; H01Q 21/24; H04B 7/0456

(52) U.S. Cl. CPC H04B 1/123; H01Q 1/246; H01Q 21/24; H04B 7/0469

(57) ABSTRACT

A base station system includes a base station radio, a baseband unit supporting at least a first and second spectrum band, and a passive antenna with a dual-polarized antenna array. The radio and baseband unit incorporate passive intermodulation (PIM) reduction features to minimize PIM interference in at least one uplink band. The base station radio has at least two RF ports, each carrying RF signals comprising both spectrum bands. A first RF signal is split by a first RF filter into separate signals for each spectrum band. These are distributed via respective RF distribution networks to generate plural component RF signals for each band. The component signals are then combined using RF combiner-filters, which are connected to a first polarization of the dual-polarized antenna elements in the antenna array.

### CROSS-REFERENCE TO RELATED APPLICATIONS

This application claims priority to U.S. Provisional Patent Application Ser. No. 63/668,155, filed Jul. 5, 2024, which is herein incorporated by reference in its entirety.

### FIELD OF THE DISCLOSURE

The present disclosure relates generally to cellular base station systems, and relates more particularly to base station systems capable of supporting at least two spectrum bands with reduced passive intermodulation interference.

### BACKGROUND

Cellular base station sites are increasingly required to support multiple spectrum bands to meet growing capacity demands and enable advanced services. Traditionally, combining multiple bands within a single antenna system introduces the risk of passive intermodulation (PIM) interference, which can degrade uplink performance by generating unwanted signals that fall within receiver bands. PIM is often caused by non-linearities at RF junctions, such as connectors or solder joints, and can be exacerbated as more bands are added or as equipment ages. To avoid PIM, operators have typically deployed separate antennas for different bands, leading to increased site complexity, higher costs, and physical constraints due to limited space or structural loading.

### SUMMARY

In one example, the present disclosure describes a base station system including at least one base station radio, a baseband unit capable of supporting at least a first spectrum band and a second spectrum band, and a passive base station antenna with at least one dual-polarized antenna array comprising a plurality of dual-polarized antenna elements. At least one of: the at least one base station radio or the baseband unit may include passive intermodulation (PIM) reduction features which operate to minimize PIM interference into at least one uplink band. The at least one base station radio may include at least two radio frequency (RF) ports, where a first radio port of the at least two RF ports carries a first RF signal that includes the at least first spectrum band and second spectrum band, and where a second radio port of the at least two RF ports carries a second RF signal that includes the at least first spectrum band and the second spectrum band. The first RF signal may connect to a first RF filter configured to split the first RF signal into at least a first spectrum band RF signal in the first spectrum band and a first spectrum band RF signal in the second spectrum band, where the first spectrum band RF signal in the first spectrum band may connect to a first RF distribution network to create a first plurality of first spectrum band component RF signals, and where the first spectrum band RF signal in the second spectrum band may connect to a second RF distribution network to create a first plurality of second spectrum band component RF signals. The first plurality of first spectrum band component RF signals and the first plurality of second spectrum band component RF signals may be combined using a first plurality of RF combiner-filters. In addition, the first plurality of RF combiner-filters may be connected to a first polarization of the plurality of dual-polarized antenna elements of a first dual-polarized antenna array of the at least one dual-polarized antenna array.

In one example, the present disclosure also describes a method of operating a base station system including at least one base station radio, where the at least one base station radio comprises at least two radio frequency (RF) ports, a baseband unit capable of supporting at least a first spectrum band and a second spectrum band, and a passive base station antenna with at least one dual-polarized antenna array comprising a plurality of dual-polarized antenna elements. For example, the method may include applying passive intermodulation (PIM) reduction features via at least one of: the at least one base station radio or the baseband unit to minimize PIM interference into at least one uplink band, applying a first RF signal that includes the at least first spectrum band and second spectrum band to a first radio port of the at least two RF ports, and applying a second RF signal that includes the at least first spectrum band and the second spectrum band to a second radio port of the at least two RF ports. The method may further include splitting the first RF signal into at least a first spectrum band RF signal in the first spectrum band and a first spectrum band RF signal in the second spectrum band via a first RF filter, creating a first plurality of first spectrum band component RF signals from the first spectrum band RF signal in the first spectrum band via a first RF distribution network, and creating a first plurality of second spectrum band component RF signals from the first spectrum band RF signal in the second spectrum band via a second RF distribution network. In addition, the method may include combining the first plurality of first spectrum band component RF signals and the first plurality of second spectrum band component RF signals using a first plurality of RF combiner-filters and transmitting the first plurality of first spectrum band component RF signals and the first plurality of second spectrum band component RF signals that are combined, where the transmitting is via a first polarization of the plurality of dual-polarized antenna elements of a first dual-polarized antenna array of the at least one dual-polarized antenna array.

### BRIEF DESCRIPTION OF THE DRAWINGS

The teachings of the present disclosure can be readily understood by considering the following detailed description in conjunction with the accompanying drawings, in which:

FIG. 1 depicts an example deployment of passive low-band antenna arrays at a base station sector;

FIG. 2 depicts an example distribution and phase shifting network for a dual-polarised antenna array;

FIG. 3 depicts an example deployment of using an antenna array which adopts combining at the antenna elements to manage passive intermodulation (PIM) interference risk;

FIG. 4 depicts example distribution and phase shifting networks of an antenna array which adopts combining at the antenna elements to manage PIM interference risk;

FIG. 5 depicts an example deployment of a dual-band radio and baseband using PIM detection and PIM avoidance features with a regular passive base station antenna to manage PIM risk;

FIG. 6 depicts an example PIM power spectral density generated from 40 W of Band 14 and 40 W of Band 29 with a PIM specification of −140 dBc, where the uplink of Band 14 is compromised by PIM interference;

FIG. 7 depicts an example PIM power spectral density generated from 40 W of Band 14 and 40 W of Band 29 with a PIM specification of −140 dBc, and using PIM avoidance features;

FIG. 8 depicts an example of distribution and phase shifting networks of an antenna array which adopts combining at the antenna elements, and which is optimized for connection to a dual-band radio using PIM avoidance features.

To facilitate understanding, identical reference numerals have been used, where possible, to designate identical elements that are common to the figures.

### DETAILED DESCRIPTION

The present disclosure describes base station systems capable of supporting at least two spectrum bands (which would ordinarily present passive intermodulation (PIM) interference risks) with no or minimal capacity loss, and with no or minimal PIM interference. In one example, the present disclosure may include (1) PIM interference avoidance features at baseband, which may deterministically schedule resource blocks from each band in a manner to avoid PIM interference on an as-needed basis, and (2) a passive antenna array configuration which combines the two bands as component signals at lower powers at the antenna elements in the antenna array. The latter aspect may provide significantly improved antenna PIM interference specification. As a result, a base station system of the present disclosure may have less reliance on PIM interference avoidance features at baseband. This in turn may ensure that maximum capacity and peak data rates can be attained from the spectrum bands, while avoiding having to host the bands on separate antenna arrays.

Cellular communications operators deploy base station sites to allow the transmission and reception of voice and data services over a service area. Cellular operators provide these voice and data services using one or more RF spectrum bands using radio equipment and base station antennas for the transmission and reception of RF signals between mobile devices and the cellular network infrastructure. Many of the spectrum bands used by cellular operators are Frequency Division Duplex (FDD) meaning there is a downlink (base station transmit, Tx) sub-band and an uplink (base station receive, Rx) sub-band which are separated in the spectral domain by a duplex frequency gap. Most radio equipment will combine Tx and Rx sub-bands onto one RF connection using a duplexing filter. Such duplex filtering allows for a reduction in the quantity of physical antennas and cabling at base station sites, since both Tx and Rx sub-bands are generally within the same bandwidth of an antenna and hence can share the same physical antenna.

Passive Intermodulation (PIM) RF energy is generated when at least two RF Tx signals from at least one Base Station are coupled together at a junction which exhibits some non-linear electrical transfer characteristics. Such PIM energy can fall into RF spectrum ranges outside of the Tx sub-bands; the ranges being a mathematical harmonic-related function of the signal RF transmission frequencies. In most cases, third order PIM products are the strongest which will have PIM spectral components at 2f1±f2 and 2f2+f1 for two Tx signals at frequencies f1 and f2. PIM becomes problematic when (1) the resulting PIM energy falls within one or more Uplink or Base Station Rx spectrum sub-bands, and (2) is of sufficient power as to desensitize the wanted RF signals arriving from mobile terminals at the Base Station antenna. These non-linear junctions can be in the conducted RF signal path such as RF cable connectors, RF signal combining filters, solder joints within the antenna, etc. Non-linear electrical behavior can occur when dissimilar metals form the junction, there is a non-uniform pressure across electrical contacts of the same metal, or oxidization on the junction. Non-linearity can also change over time due to ageing, oxidization, weathering, temperature cycling and induced mechanical stresses such as vibration.

Mobile operators periodically add new spectrum at base station sites to address growing capacity needs and to also allow new services such as 4G and 5G to be offered. Such new spectrum can be spectrum from what the operator already owns or has license to operate, or newly acquired spectrum from spectrum auctions or other acquisition processes. When a base station site starts transmitting in the new spectrum, the number of inter modulating spectral products which can be generated from any PIM sources will increase. The probability that one or more of these PIM generated spectral products will fall into one or more of the base station receiver uplink sub-bands will also increase. Many mobile operators today typically have between five and ten different spectrum bands ranging from 600 MHz to 4000 MHz. As just one example, a major cellular operator in the United States may operate spectrum on the 3GPP designated bands of Band 12, Band 29, Band 14, Band 5 at what is called low-band spectrum, or below 1 GHz. Most commercial passive bases station antenna arrays support all these bands in the spectrum range 698-894 MHz. However, if all these bands were transmitted from the same antenna array, it can be shown that there would be PIM energy falling into multiple uplink sub-bands.

To avoid PIM interference risks at a base station site, generally only certain bands are combined at a same, shared radio hardware in the form of a multi-band radio (and hence also sharing the same radiating antenna array(s)). Such band combinations may involve careful planning to ensure that PIM interference is not generated in one or more of the uplink sub-bands. For example, 3GPP Band 5 and Band 12 spectrum can be supported using the same radio hardware with no, or little risk of PIM energy falling into the uplink sub-bands of Band 5 or Band 12. On the other hand, if 3GPP Band 12 and Band 14 spectrum is delivered through a common radio, there may be PIM energy which would fall into both Band 12 and Band 14 uplink sub-bands. In such an example, some form of PIM mitigation measures may be deployed. The same PIM interference risk exists for combining Band 12 with Band 29, and for combining Band 14 with Band 29. Given these PIM interference risks, it is more typical that a base station site has separated passive base station antenna positions for a base station sector to support such low band spectrum, and therefore the bands do not share the same conductive RF path. For a three-sector base station site, using all low-band spectrum, this can amount to nine individual passive base station antenna positions. Mid-band spectrum in 3GPP Band 25, Band 66, and Band 30 covering the spectrum range 1695-2400 MHz can also be hosted on these antenna positions using multi-band passive base station antennas, which may have antenna arrays for low band and mid band spectrum ranges co-located within the same physical backplane, housing, and radome. C-Band spectrum in the range 3300-3980 MHz may also be hosted on one or two Active Antenna Systems (AASs) covering different spectral ranges in C-Band, where the AASs use massive multiple input-multiple output (MIMO) features.

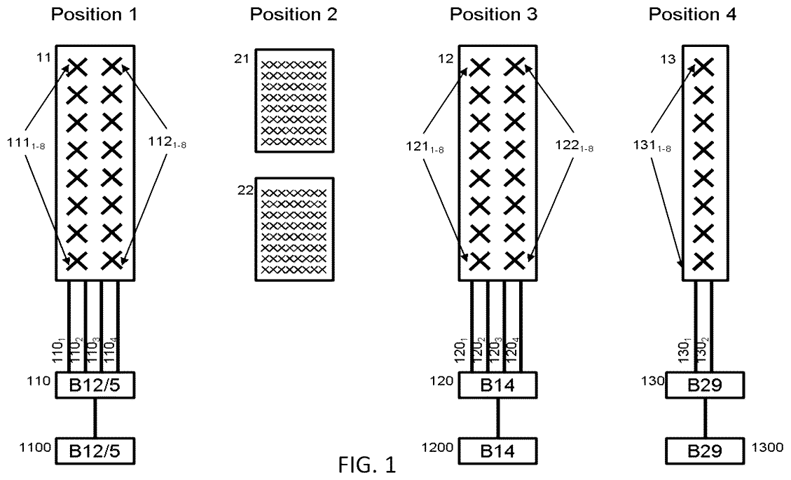

FIG. 1 illustrates an example case of three passive base station antennas, or antenna arrays (11, 12, 13) and two AASs (21, 22) which may be deployed at one sector of a base station site. A first passive base station antenna (11) occupying a first position may include two dual-polarised arrays with a first array of eight dual-polarised antenna elements (111₁₋₈) and a second array of eight dual-polarised antenna elements (112₁₋₈). The first passive base station antenna (11) may be connected to a first radio (110) via four RF cables (110₁₋₄), where the radio is of dual-band configuration supporting 3GPP Band 12 and Band 5 spectrum in a 4T4R configuration, meaning all four RF cables can carry Tx and Rx signals for both Bands 12 and Band 5. The first radio (110) may be connected to a first baseband unit (1100), e.g., via a fiber connection. The first baseband unit (1100) may perform scheduling functions for data traffic for Bands 12 and Band 5 as part of a 3GPP RAN architecture supporting 4G and/or 5G cellular services.

A second passive base station antenna (12) occupying a third position may include two dual-polarised arrays with a first array of eight dual-polarised antenna elements (121₁₋₈) and a second array of eight dual-polarised antenna elements (122₁₋₈). The second passive base station antenna may be connected to a second radio (120) via four RF cables (120₁₋₄), where the radio is of single-band configuration supporting 3GPP Band 14 spectrum in 4T4R configuration, meaning all four RF cables can carry Tx and Rx signals for Band 14. The second radio (120) may be connected to a second baseband unit (1200), e.g., via a fiber connection. The second baseband unit (1200) may perform scheduling functions for data traffic for Band 14 as part of a 3GPP RAN architecture supporting 4G and/or 5G cellular services.

A third passive base station antenna (13) in a fourth position may include one dual-polarised array of eight dual-polarised antenna elements (131₁₋₈). The third passive base station antenna may be connected to a third radio (130) via two RF cables (130₁, 130₂), where the radio is of single-band configuration supporting 3GPP Band 29 spectrum in 2T0R configuration, meaning both RF cables can carry downlink Tx-only signals for Band 29. The third radio (130) may be connected to a third baseband unit (1300), e.g., via a fiber connection. The third baseband unit (1300) may perform scheduling functions for downlink data traffic for Band 29 as part of a 3GPP RAN architecture supporting 4G and 5G cellular services.

Two AASs (21, 22) may be arranged in a vertical alignment and occupy a second position in the base station sector. These AASs may deliver C-Band spectrum over the range 3300-3980 MHz and are included in FIG. 1 for completeness to illustrate a typical sector deployment. It is also common for a sector to host mid-band spectrum, e.g., in the range 1695-2400 MHz. However, for purposes of clarity and ease of illustration, mid-band radios and/or the antenna arrays to which they are connected are omitted from FIG. 1. In particular, FIG. 1 aims to focus on low-band spectrum to help illustrate the current problem faced by operators.

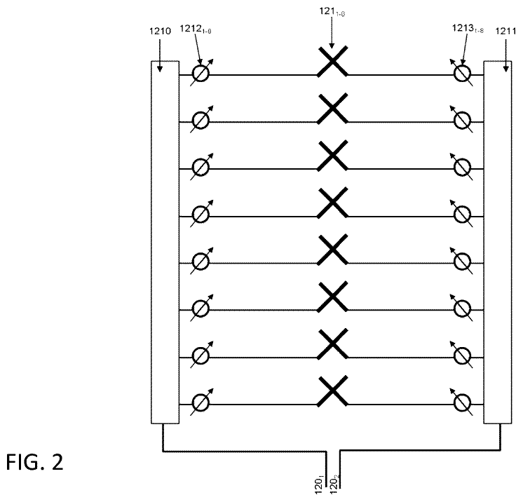

FIG. 2 illustrates an example configuration of the first array (121₁₋₈) of the second passive base station antenna (12) of FIG. 1. The first polarization of the eight dual-polarized antenna elements (121₁₋₈) are connected to a first distribution network (1210) and a first phase shifting network comprising a plurality of phase shifters (1212₁₋₈), which perform the function of distributing component signals from the RF signal connected to the second base station radio (120) of FIG. 1 via a first base station radio port and RF cable (120₁), e.g., in such a manner as to develop a far field radiation pattern suitable for cellular networks where the main beam can be tilted in the elevation plane through the adjustment of the phase shifters (1212₁₋₈). The second polarization of the eight dual-polarized antenna elements (121₁₋₈) are connected to a second distribution network (1211) and a second phase shifting network comprising a plurality of phase shifters (1213₁₋₈), which perform the function of distributing component signals from the RF signal connected to the second base station radio (120) via a second base station radio port and RF cable (120₂), e.g., in such a manner as to develop a far field radiation pattern suitable for cellular networks where the main beam can be tilted in the elevation plane through adjustment of the phase shifters (1213₁₋₈). In one example, the phase shifting networks (1212₁₋₈) and (1213₁₋₈) are mechanically coupled such that the beam tilt associated with both polarizations are tilted together. The precise distribution networks, phase shifting networks, and dual-polarized elements can take various forms and the above description is provided for purposes of illustration in connection with examples of the present disclosure. A similar arrangement of distribution networks and phase shifting may be used on the second array (122₁₋₈) of the second passive base station antenna (12) of FIG. 1, and not shown for clarity.

The PIM interference performance of any passive base station antenna, such as the second passive base station antenna (12) of FIG. 1, may be limited by the non-linearity of material properties of the materials used in the conductive RF path within the antenna or base station/antenna system, e.g., including solder joints, internal connectors, filters, phase shifters and baluns connecting individual antenna elements. A wide variety of antenna arrays can achieve a PIM interference performance specification of −150 dBc when 2×20 W continuous wave (CW) tones are applied to any one of the antenna ports. This −150 dBc is deemed as an industry benchmark. However, for the installation of antennas at a base station site, a lower system PIM specification may be adopted in consideration of other components in the RF path external to the antenna, such as jumper cables, connectors, filters, and combiners. Additionally, PIM margin may be included to account for ageing effects on materials used in the antenna, temperature variations, and vibration throughout the lifetime of the antenna and radio deployment in the base station sector. For instance, −140 dBc may be used as an installed PIM interference performance assumption. Finally, installation teams may perform PIM tests of the antennas in situ at sites with an installation acceptance of around −143 dBc, for example.

It should be noted that for any antenna deployment, the PIM interference performance may vary from antenna to antenna, sector to sector, and site to site, and may vary over time due to ageing and temperature cycling. Some antennas can see PIM interference performance improve over time, while some may degrade over time. The result is a statistical distribution of PIM interference performance, with commercially acceptable antennas typically exceeding −140 dBc, for instance.

Many base station sites do not have the physical space to accommodate three passive multi-band antennas and two AAS on each sector due to factors such as structural loading limitations, weight limitations, wind-loading limitations, risk of rental increases, or zoning limitations. This can apply to existing sites or new sites. Where such limitations occur, an operator may choose from several options which include the following:

Option 1—Not to deploy one of the spectrum bands. For example, a cellular network operator may decide not to deploy Band 29 spectrum, or the like. PIM interference can be avoided with this approach, but a disadvantage is that spectrum is unable to be used, which in turn reduces the inherent capacity of the base station site.

Option 2—Combine two bands with two radios sharing low-band antenna arrays at one of the passive base station antennas, but using lower RF power in one or more of the bands to help ensure PIM energy is minimized and maintained. This is an improved option compared to the first strategy above because at least some spectral capacity at reduced range is present, rather than no spectral capacity in the case above when a band is simply omitted. Using the combining approach, both bands may share a common radiated antenna beam tilt, which may constrain wider network design and network optimization techniques. Finally, there can remain some PIM interference risks if there is degradation in the antenna system over time, temperature cycling, weathering, etc. As such, PIM interference avoidance cannot be completely guaranteed over the lifetime of the antenna system.

Option 3—Distribute the RF power in two bands from two radios into lower power component signals and combine the component signals across a plurality of dual-polarised antenna elements of the low-band antenna arrays of one of the passive base station antennas. This approach ensures that PIM energy is significantly reduced, since only low power component signals from each band are combined. This approach also allows independent beam tilts to be maintained for each band. Accordingly, this is an improved option compared to the above, since in the present example, all of the spectrum at full rated radio powers is available. However, there can remain some PIM interference risks if there is degradation in the antenna system over time, temperature cycling, weathering, etc. As such, PIM interference avoidance cannot be completely guaranteed over the lifetime of the antenna system.

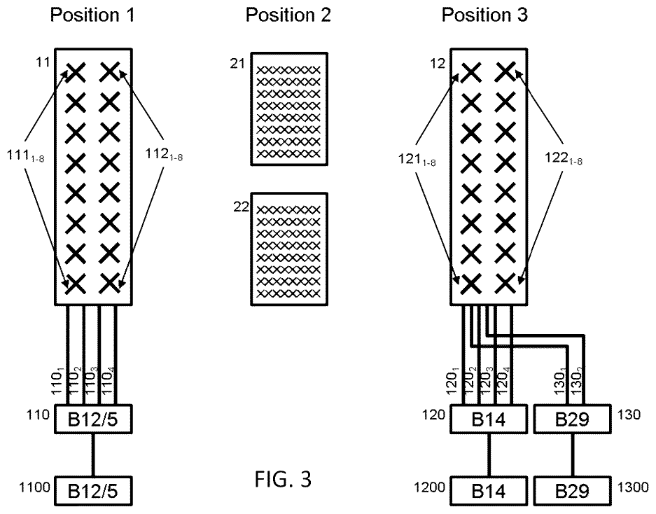

FIG. 3 illustrates this option in addition detail. For instance, the second passive base station antenna (12) (which may be the same as the second passive base station antenna (12) of FIG. 1) may have two dual-polarized arrays, with a first array of eight dual-polarized antenna elements (121₁₋₈) and a second array of eight dual-polarized antenna elements (122₁₋₈). The first dual-polarized array (121₁₋₈) may host both Band 14 and Band 29 spectrum connecting to two ports (120₁, 1202) of a four-port Band 14 radio (120) and the two ports (130₁, 130₂) of a Band 29 radio (130). The second dual-polarized array (122₁₋₈) may host only Band 14 spectrum connecting to two ports (120₃, 120₄) of the four-port Band 14 radio (120). The Band 14 radio (120) is in turn connected to a baseband unit (1200), and the Band 29 radio (130) is in turn connected to a baseband unit (1300).

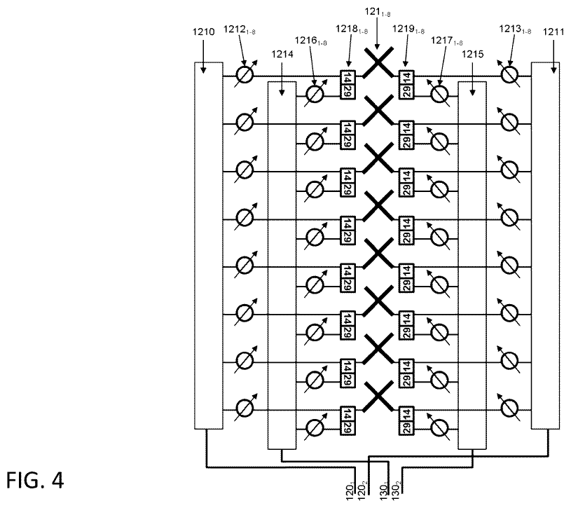

FIG. 4 further illustrates the configuration of the first dual-polarized array (121₁₋₈) of the second passive base station antenna (12). This may include all of the same components as illustrated in FIG. 2 for connection to two ports and cables of the Band 14 radio (120₁, 120₂). FIG. 4 additionally includes distribution networks (1214, 1215) for each of the two polarizations, and phase shifting networks (1216₁₋₈, 1217₁₋₈) for each of the two polarizations which provide the component signals for each of the two polarizations from the Band 29 radio ports and cables (130₁, 130₂). The component signals from Band 14 and Band 29 may be combined at the dual-polarized antenna elements (121₁₋₈) using filter-combiners for each polarization. For instance, the first polarization may use combiner-filters (1218₁₋₈) and the second polarization may use combiner-filters (1219₁₋₈). Notably, Band 14 and Band 29 spectrum are combined at lower powers than had RF energy from the respective bands been combined before connection to the antenna. In addition, this arrangement may typically deliver a cross-band PIM interference performance of around-160 dBc or better. Furthermore, Band 29 and Band 14 spectrum can be beam-tilted independently of each other, which provides important network design optimization freedoms. For example, each band may have different coverage and quality requirements, and/or one of the bands may not be deployed on all sites in a cluster of base station cells.

Option 4—Deploy adaptive PIM cancellation. This may include solutions which operate in the baseband unit, solutions which operate in the radio unit, and/or third-party devices which operate in-line of the baseband signalling between radio and baseband units. There are numerous approaches but many attempt to create a model of the PIM sources and use this model with signal cancellation methods at the receive signals, along with periodic updating and tuning of the PIM model. However, such features can be costly and/or may not be available to license. In addition, these techniques may not provide sufficient PIM margin or may not perform robustly for all scenarios, such as under high frequency mechanical vibration events.

Option 5—Reduce the number of transmission branches from four to two. For example, Band 14 radio can be configured to operate in a 2T2R or 2T4R mode, rather than a 4T4R mode, where the Band 14 radio may be connected to one dual-polarized array of the two dual-polarized arrays of the passive base station antenna. In this case, the second band, e.g., Band 29, may also be configured to use only the second dual-polarized array of the two dual-polarized arrays of the passive base station antenna, thus ensuring that both bands do not share a common conducted RF path, and only share the physical space of the base station antenna. The disadvantage of this approach is that there is a reduction in MIMO order from 4×4 or 4×2 on the downlink to 2×2 on the downlink. Depending upon the radio channel and conditions, this can amount to a significant capacity loss (of up to 30%) and can also have an impact on cell edge coverage service because 4T4R configurations can exploit the larger aperture and the inherent beamforming from using two dual-polarized arrays.

Option 6-Use of a dual-band radio, which brings together two bands which have some PIM interference risks, but using PIM detection and PIM interference avoidance features at baseband. For instance, in this example, PIM interference avoidance features may rely on jointly scheduling the transmission of data in available LTE or NR resource blocks across two spectrum bands in such a manner as to avoid PIM energy falling into the respective uplink sub-band resource blocks. Additionally, PIM avoidance may be invoked only when PIM energy/interference is detected. For instance, this may maximize overall spectrum utilization for antenna systems which may have better PIM interference performance, given that PIM interference performance of installed antenna systems will have several dBs of statistical variation over time and locations. The advantage of this approach is that PIM interference can be managed deterministically, and therefore helps ensure PIM interference is avoided, even in the event that an antenna system degrades, or even fails. The disadvantage of this approach is that there may be some inherent network capacity loss when deployed across a plurality of base station sectors. For instance, some sectors may be busier than others, some antennas may be closer to the −140 dBc PIM interference performance than others, etc. In these cases, activating PIM interference avoidance may result in not all resource blocks being usable, and hence a reduction in capacity. However, across a wide range of scenarios, this approach may provide better overall performance than the options described above.

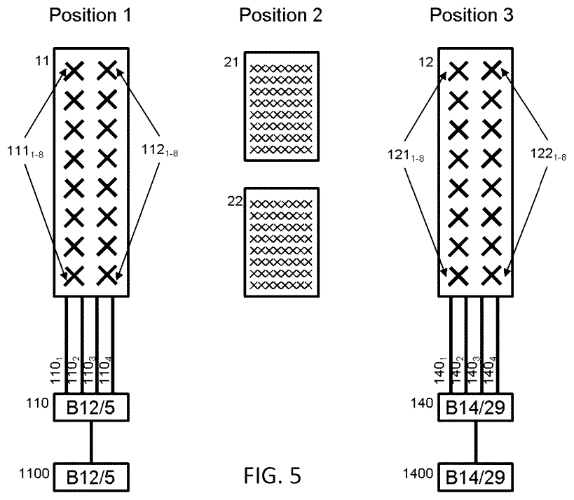

The arrangement for option 6 is illustrated in FIG. 5 where the dual-band radio (140) has four ports for connection to the antenna arrays (121₁₋₈) and (122₁₋₈) via RF cables (140₁₋₄). The dual-band radio (140) may be connected to baseband unit (1400) where PIM interference avoidance may be applied, e.g., through joint scheduling of resource blocks across Band 14 and Band 29. It should again be noted that the antenna (12) in FIG. 5 may be the same as or similar to that depicted in FIG. 2 (and likewise for antenna (11) and AASs (21, 22)).

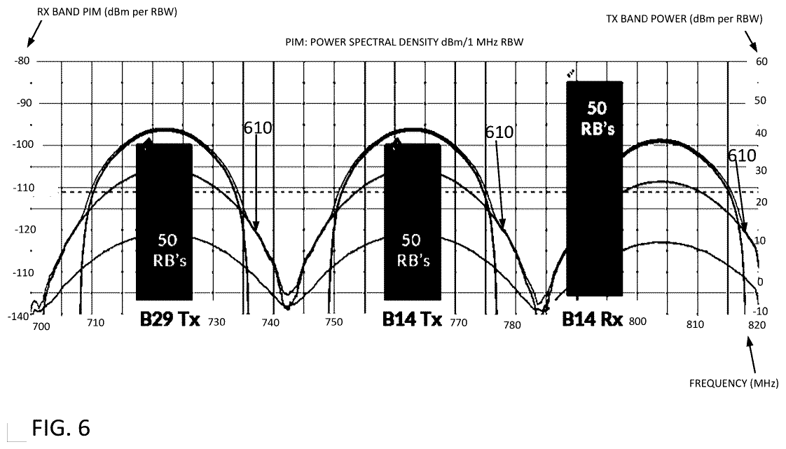

FIG. 6 illustrates an example of how combining Band 29 and Band 14 together results in PIM energy falling into the Band 14 uplink sub-band and causing harmful interference. FIG. 6 is a power spectral density plot over the range 700-820 MHz, with a first y-axis label on the right for downlink and a second y-axis label on the left for the uplink. Two downlink signal spectral occupancy ranges are shown in solid blocks; one for Band 29 and one for Band 14, e.g., each nominally a 10 MHz channel and each showing all 50 resource blocks occupied, which may equate to a power of 40 W per band. The spectral occupancy range for the uplink sub-band of Band 14 is also shown as a rectangular block, e.g., of nominally 10 MHz bandwidth where all of the respective 50 resource blocks are occupied. The curve (also labelled as 610) depicts the PIM power spectral density in the uplink when an antenna system PIM interference specification of −140 dBc is assumed. In this example, PIM energy encroaches well into the Band 14 uplink sub-band and is above the radio noise threshold for well over half of the 50 resource blocks. This clearly demonstrates a performance-compromised configuration.

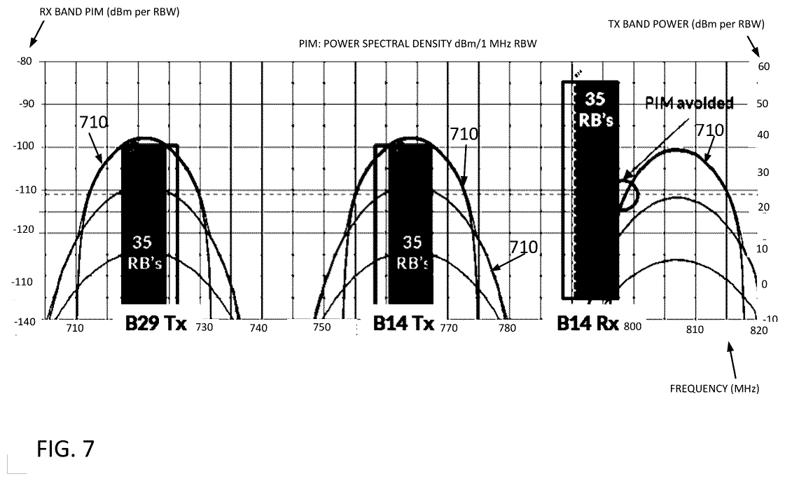

FIG. 7 illustrates a PIM power spectral density plot (also labelled as 710) for the same arrangement as for FIG. 6, but now adopting a PIM interference avoidance feature. In this example, only 35 Resource Blocks of each band are used. For instance, FIG. 7 illustrates the specific arrangement of using the lowest 35 resource blocks in Band 29 and the highest 35 resource blocks in Band 14. This helps ensures that harmful PIM energy falls just outside of the Band 14 uplink sub-band. Although the example of FIG. 7 uses a worst case-140 dBc PIM specification assumption, it highlights that PIM interference can be avoided, but at the expense of some capacity loss from a grade-of-service metric, and some degradation in peak data rates from a quality-of-service metric. In this example, around 30% capacity is lost in using a maximum of 70 resource blocks overall versus an available 100 resource blocks in the case that PIM interference was not a problem. In these examples, for the purposes of clarity, transmission of common channels is not considered. Similarly, synchronization of data which can occupy portions of different resource blocks across the entire 50 resource blocks within each band is not considered.

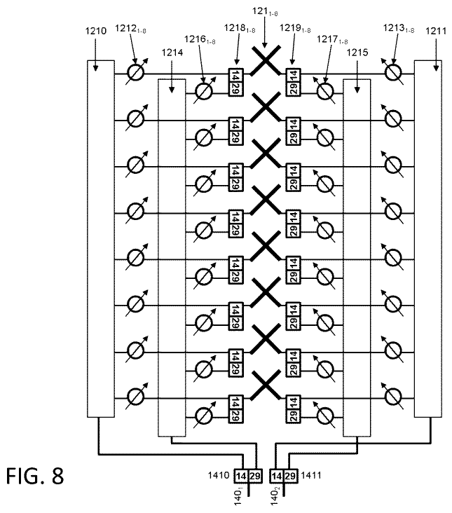

FIG. 8 illustrates an additional example that brings together the features of two of the aforementioned options for mitigating PIM interference. In particular, this example may include a dual-band radio, e.g., as described in option 6, which combines Band 14 and Band 29 and which may provide PIM detection and PIM avoidance features at baseband, and where the dual-band radio is connected to a passive base station antenna configuration, e.g., as described in option 3. The arrangement may be the same as illustrated in FIG. 5, e.g., where the dual-band radio (140) has four ports for connection to the antenna arrays via RF cables (140₁₋₄). The dual-band radio (140) is connected to baseband unit (1400) where PIM avoidance through joint scheduling of resource blocks across Band 14 and Band 29 may be carried out. However, the first array of antenna (12) may have a configuration as depicted in FIG. 8.

To further illustrate, the example of FIG. 8 may include all the features and components as illustrated described in connection with FIG. 4, but may additionally include filters (1410) and (1411), which may function as band splitters. The first radio port and cable from the dual-band radio (140₁) may connect to a first filter (1410) which divides the dual-band radio signal into two single band signals: Band 29 and Band 14. The Band 14 RF signals are then routed to distribution network (1210) and phase shifting network (1212₁₋₈) to create a plurality of component Band 14 signals. Similarly, the Band 29 RF signals are routed to distribution network (1214) and phase shifting network (1216₁₋₈) to create a plurality of component Band 29 signals. The plurality of Band 14 and Band 29 signals are re-combined using filter combiners (1218₁₋₈) for connection to a first polarization of the dual-polarized antenna elements of the first dual-polarized antenna array. The second radio port and cable from the dual-band radio (140₂) may connect to a second filter (1411) which divides the dual-band radio signal into two single band signals: Band 29 and Band 14. The Band 14 RF signals are then routed to distribution network (1211) and phase shifting network (1213₁₋₈) to create a plurality of component Band 14 signals. The Band 29 RF signals are then routed to distribution network (1215) and phase shifting network (1217₁₋₈) to create a plurality of component Band 29 signals. The plurality of Band 14 and Band 29 signals are re-combined using filter combiners (1219₁₋₈) for connection to a second polarization of the dual-polarized antenna elements of the first dual-polarized antenna array.

It should be noted that the phase shifting networks depicted in FIG. 8 are intended to be illustrative merely to describe how the radiated main beam can be tilted through changing the phase profile along the array. Thus, it should be noted that in one example, the phase shifting networks may also be mechanically and/or electrically coupled so that the tilt of the beam for both polarizations of the same band are changed together. It should also be appreciated that in another example, the present disclosure may include a base station system that combines aspects of option 3 with option 4, e.g., a base station system which adopts combining at the antenna elements via distribution and phase shifting networks of an antenna array in conjunction with a dual-band radio using PIM interference cancellation features.

While the foregoing describes various examples in accordance with one or more aspects of the present disclosure, other and further example(s) in accordance with the one or more aspects of the present disclosure may be devised without departing from the scope thereof, may be determined by the claim(s) that follow and equivalents thereof. For instance, although the foregoing examples are illustrated and described primarily in connection with combinations of 3GPP Bands 14 and 29, and Bands 12 and 14, examples of the present disclosure may include any combinations of bands that may result in PIM interference, such as a combination of 3GPP Bands 20 and 28 (which may be more common in Europe), and so forth.

In addition, aspects of various embodiments are specified in the claims. Those and other aspects of various embodiments are specified in the following numbered clauses.

What is claimed is:

1. A base station system comprising:
at least one base station radio;
a baseband unit capable of supporting at least a first spectrum band and a second spectrum band; and
a passive base station antenna with at least one dual-polarized antenna array comprising a plurality of dual-polarized antenna elements,
wherein at least one of: the at least one base station radio or the baseband unit includes passive intermodulation (PIM) reduction features which operate to minimize PIM interference into at least one uplink band,
wherein the at least one base station radio comprises at least two radio frequency (RF) ports, where a first radio port of the at least two RF ports carries a first RF signal that includes the at least the first spectrum band and the second spectrum band, and where a second radio port of the at least two RF ports carries a second RF signal that includes the at least the first spectrum band and the second spectrum band,
wherein the first RF signal connects to a first RF filter configured to split the first RF signal into at least a first spectrum band RF signal in the first spectrum band and a first spectrum band RF signal in the second spectrum band, where the first spectrum band RF signal in the first spectrum band connects to a first RF distribution network to create a first plurality of first spectrum band component RF signals, and where the first spectrum band RF signal in the second spectrum band connects to a second RF distribution network to create a first plurality of second spectrum band component RF signals,
wherein the first plurality of first spectrum band component RF signals, and the first plurality of second spectrum band component RF signals are combined using a first plurality of RF combiner-filters, and
wherein the first plurality of RF combiner-filters is connected to a first polarization of the plurality of dual-polarized antenna elements of a first dual-polarized antenna array of the at least one dual-polarized antenna array.

2. The base station system of claim 1, wherein the second RF signal connects to a second RF filter configured to split the second RF signal into at least a second spectrum band RF signal in the first spectrum band and a second spectrum band RF signal in the second spectrum band, where the second spectrum band RF signal in the first spectrum band connects to a third RF distribution network to create a second plurality of first spectrum band component RF signals, and where the second spectrum band RF signal in the second spectrum band connects to a fourth RF distribution network to create a second plurality of second spectrum band component RF signals,
wherein the second plurality of first spectrum band component RF signals and the second plurality of second spectrum band component RF signals are combined using a second plurality of RF combiner-filters, and
wherein the second plurality of RF combiner-filters is connected to a second polarization of the plurality of dual-polarized antenna elements of the first dual-polarized antenna array of the at least one dual-polarized antenna array.

3. The base station system of claim 2, further comprising at least one of:
the first RF filter; or
the second RF filter.

4. The base station system of claim 2, further comprising at least one of:
the first plurality of RF combiner-filters; or
the second plurality of RF combiner-filters.

5. The base station system of claim 2, further comprising at least one of:
the first RF distribution network;
the second RF distribution network;
the third RF distribution network; or
the fourth RF distribution network.

6. The base station system of claim 2, wherein the first RF distribution network comprises a first plurality of phase shifting devices to impart phase shifts in the first plurality of first spectrum band component RF signals, and wherein the second RF distribution network comprises a second plurality of phase shifting devices to impart phase shifts in the first plurality of second spectrum band component RF signals.

7. The base station system of claim 6, wherein the third RF distribution network comprises a third plurality of phase shifting devices to impart phase shifts in the second plurality of first spectrum band component RF signals, and wherein the fourth RF distribution network comprises a fourth plurality of phase shifting devices to impart phase shifts in the second plurality of second spectrum band component RF signals.

8. The base station system of claim 1, wherein the first spectrum band is 3GPP Band 14 and the second spectrum band is 3GPP Band 29.

9. The base station system of claim 1, wherein the first spectrum band is 3GPP Band 14 and the second spectrum band is 3GPP Band 12.

10. The base station system of claim 1, wherein the first spectrum band is 3GPP Band 20 and the second spectrum band is 3GPP Band 28.

11. The base station system of claim 1, wherein the plurality of dual-polarized antenna elements comprises at least four dual-polarized antenna elements.

12. The base station system of claim 1, wherein the at least one base station radio has at least 4 ports.

13. The base station system of claim 1, wherein the PIM reduction features comprise PIM avoidance features.

14. The base station system of claim 1, wherein the PIM reduction features comprise PIM cancellation features.

15. The base station system of claim 1, wherein the baseband unit further includes PIM detection features.

16. A method of operating a base station system including at least one base station radio, wherein the at least one base station radio comprises at least two radio frequency (RF) ports, a baseband unit capable of supporting at least a first spectrum band and a second spectrum band, and a passive base station antenna with at least one dual-polarized antenna array comprising a plurality of dual-polarized antenna elements, the method comprising:
applying passive intermodulation (PIM) reduction features via at least one of: the at least one base station radio or the baseband unit to minimize PIM interference into at least one uplink band;
applying a first RF signal that includes the at least first spectrum band and second spectrum band to a first radio port of the at least two RF ports;
applying a second RF signal that includes the at least first spectrum band and the second spectrum band to a second radio port of the at least two RF ports;
splitting the first RF signal into at least a first spectrum band RF signal in the first spectrum band and a first spectrum band RF signal in the second spectrum band via a first RF filter;
creating a first plurality of first spectrum band component RF signals from the first spectrum band RF signal in the first spectrum band via a first RF distribution network;
creating a first plurality of second spectrum band component RF signals from the first spectrum band RF signal in the second spectrum band via a second RF distribution network;
combining the first plurality of first spectrum band component RF signals and the first plurality of second spectrum band component RF signals using a first plurality of RF combiner-filters; and
transmitting the first plurality of first spectrum band component RF signals and the first plurality of second spectrum band component RF signals that are combined, wherein the transmitting is via a first polarization of the plurality of dual-polarized antenna elements of a first dual-polarized antenna array of the at least one dual-polarized antenna array.

17. The method of claim 16, further comprising:
splitting the second RF signal into at least a second spectrum band RF signal in the first spectrum band and a second spectrum band RF signal in the second spectrum band via a second RF filter;
creating a second plurality of first spectrum band component RF signals from the second spectrum band RF signal in the first spectrum band via a third RF distribution network;
creating a second plurality of second spectrum band component RF signals from the second spectrum band RF signal in the second spectrum band via a fourth RF distribution network;
combining the second plurality of first spectrum band component RF signals and the second plurality of second spectrum band component RF signals using a second plurality of RF combiner-filters; and
transmitting the second plurality of first spectrum band component RF signals and the second plurality of second spectrum band component RF signals that are combined, wherein the transmitting is via a second polarization of the plurality of dual-polarized antenna elements of the first dual-polarized antenna array of the at least one dual-polarized antenna array.

18. The method of claim 17, further comprising:
imparting phase shifts in the first plurality of first spectrum band component RF signals via a first plurality of phase shifting devices of the first RF distribution network; and
imparting phase shifts in the first plurality of second spectrum band component RF signals via a second plurality of phase shifting devices of the second RF distribution network.

19. The method of claim 18, further comprising:
imparting phase shifts in the second plurality of first spectrum band component RF signals via a third plurality of phase shifting devices of the third RF distribution network; and
impart phase shifts in the second plurality of second spectrum band component RF signals via a fourth plurality of phase shifting devices of the fourth RF distribution network.

20. The method of claim 16, wherein the PIM reduction features comprise at least one of:
PIM avoidance features; or
PIM cancellation features.
